(19) United States
(12) Patent Application Publication
(10) Pub. No.: US 2024/0125896 A1
(43) Pub. Date: Apr. 18, 2024

(54) APPARATUS FOR DRIVER ASSISTANCE AND METHOD OF CONTROLLING THE SAME

(71) Applicant: HL KLEMOVE CORP., Incheon (KR)

(72) Inventors: Jingu LEE, Gyeonggi-do (KR); Junghwan Choi, Seoul (KR); Hanbyul Lee, Seoul (KR)

(21) Appl. No.: 18/221,878

(22) Filed: Jul. 14, 2023

(30) Foreign Application Priority Data
Oct. 11, 2022 (KR) 10-2022-0130061

(51) Int. Cl. G01S 7/35; G01S 13/58; G01S 13/931

(52) U.S. Cl. CPC G01S 7/35; G01S 7/356; G01S 13/584; G01S 13/931

(57) ABSTRACT

An apparatus for driver assistance includes a radar installed to a vehicle, having a sensing area outside the vehicle, and configured to provide object data, and a controller configured to identify a distance to an object from the vehicle and a moving speed of the object based on the object data. The radar includes an antenna array, a signal processing circuit configured to provide a transmission signal to the antenna array to transmit radio waves and acquire a reception signal corresponding to radio waves received by the antenna array, and a signal processor configured to control the signal processing circuit to provide a pre-chirp signal including a plurality of pre-chirps and a main chirp signal including a plurality of main chirps to the antenna array. The number of pre-chirps is less than the number of main chirps.

### CROSS-REFERENCE TO RELATED APPLICATION

This application claims the benefit of Korean Patent Application No. 10-2022-0130061, filed on Oct. 11, 2022 in the Korean Intellectual Property Office, the disclosure of which is incorporated herein by reference in its entirety.

### BACKGROUND

### 1. Technical Field

Embodiments of the present disclosure generally relate to an apparatus including a radar and a method of controlling the same.

### 2. Description of the Related Art

Vehicles are the most common transportation in modern society, and the number of people using the vehicles is increasing. Although there are advantages such as easy long-distance travel and comfortable living with the development of a vehicle technology, a problem that road traffic conditions deteriorate and traffic congestion becomes serious in densely populated places often occurs.

Recently, research on vehicles equipped with an advanced driver assist system (ADAS) for actively providing information on a vehicle condition, a driver condition, and/or a surrounding environment in order to reduce a driver's burden, provide assistance in driving a vehicle, and enhance convenience is actively progressing.

As examples of the ADASs mounted on the vehicle, there are lane departure warning (LDW), lane keeping assist (LKA), high beam assist (HBA), autonomous emergency braking (AEB), traffic sign recognition (TSR), adaptive cruise control (ACC), blind spot detection (BSD), etc.

The ADAS may collect information or data on a surrounding environment and process the collected information. In addition, the ADAS may recognize objects and design a route for the vehicle to travel based on the processing of the collected information.

### SUMMARY

Therefore, it is an aspect of the present disclosure to provide an apparatus including a radar and a method of controlling the same.

Additional aspects of the disclosure will be set forth in part in the description which follows and, in part, will be obvious from the description, or may be learned by practice of the disclosure.

In accordance with one aspect of the present disclosure, an apparatus for driver assistance includes a radar installed on a vehicle, having a sensing area outside the vehicle, and configured to provide object data, and a controller configured to identify a distance to an object around the vehicle and a moving speed of the object based on a processing the object data. The radar includes an antenna array, a signal processing circuit configured to provide a transmission signal to the antenna array to transmit radio waves and acquire a reception signal corresponding to radio waves received by the antenna array, and a signal processor configured to control the signal processing circuit to provide a pre-chirp signal including a plurality of pre-chirps and a main chirp signal including a plurality of main chirps to the antenna array. The number of pre-chirps is smaller than the number of main chirps.

The antenna array may sequentially transmit radio waves corresponding to the pre-chirp signal and radio waves corresponding to the main chirp signal, and receive radio waves reflected from the object around the vehicle.

The signal processing circuit may acquire a first reflection chirp signal corresponding to the radio waves reflected from the object around the vehicle while transmitting the pre-chirp signal, mix the pre-chirp signal with the first reflection chirp signal, and provide a first intermediate frequency signal in which the pre-chirp signal and the first reflection chirp signal are mixed to the signal processor.

The signal processor may provide the object data including information on the distance to the object and the moving speed of the object based on the first intermediate frequency signal, and provide a bin mask corresponding to at least one bin not including data corresponding to the distance to the object.

The signal processor may transform the plurality of first intermediate frequency signals corresponding to the plurality of pre-chirps into a plurality of pieces of first frequency domain data through a fast Fourier transform, respectively, and store a first frequency domain matrix including the plurality of pieces of first frequency domain data.

The signal processor may transform data corresponding to the same frequency among the plurality of pieces of first frequency domain data into a plurality of pieces of first phase domain data through the fast Fourier transform, and store a first phase domain matrix including the plurality of pieces of first phase domain data.

The signal processor may provide the object data including information on the distance to the object and the moving speed of the object based on the plurality of pieces of first phase domain data included in the first phase domain matrix.

The phase domain matrix may include a plurality of first bins corresponding to different distances. The signal processor may provide a bin mask corresponding to at least one bin not including data corresponding to the distance to the object among the plurality of first bins.

The signal processing circuit may acquire a second reflection chirp signal corresponding to the radio waves reflected from the object around the vehicle while transmitting the main chirp signal, mix the main chirp signal with the second reflection chirp signal, and provide a second intermediate frequency signal in which the main chirp signal and the second reflection chirp signal are mixed to the signal processor. The signal processor may process the second intermediate frequency signal, filter the processed signal using the bin mask, and provide the object data including the information on the distance to the object and the moving speed of the object based on the filtered signal.

The signal processor may transform a plurality of second intermediate frequency signals corresponding to the plurality of pre-chirps into a plurality of pieces of second frequency domain data through a fast Fourier transform, respectively, filter data corresponding to the at least one bin among the plurality of pieces of second frequency domain data using the bin mask, and store a second frequency domain matrix including the plurality of pieces of filtered second frequency domain data.

The signal processor may transform data corresponding to the same frequency among the plurality of pieces of filtered second frequency domain data into a plurality of pieces of second phase domain data through the fast Fourier transform, and store a second phase domain matrix including the plurality of pieces of second phase domain data.

The signal processor may provide the object data including the information on the distance to the object and the moving speed of the object based on the plurality of pieces of second phase domain data included in the second phase domain matrix.

A frequency slope of each of the plurality of pre-chirps may be different from a frequency slope of each of the plurality of main chirps.

In accordance with another aspect of the present disclosure, a method of controlling an apparatus including an antenna array installed on a vehicle includes providing a pre-chirp signal including a plurality of pre-chirps and a main chirp signal including a plurality of main chirps to the antenna array, sequentially transmitting, by the antenna array, radio waves corresponding to the pre-chirp signal and radio waves corresponding to the main chirp signal, and receiving, by the antenna array, radio waves reflected from an object around the vehicle, The number of pre-chirps may be smaller than the number of main chirps.

The method may further include acquiring a first reflection chirp signal corresponding to the radio waves reflected from the object around the vehicle while transmitting the pre-chirp signal, mixing the pre-chirp signal with the first reflection chirp signal, and acquiring a first intermediate frequency signal in which the pre-chirp signal and the first reflection chirp signal are mixed.

The method may further include providing object data including information on a distance to the object and a moving speed of the object based on the first intermediate frequency signal.

The method may further include providing a bin mask corresponding to at least one bin not including data corresponding to the distance to the object.

The method may further include acquiring a second reflection chirp signal corresponding to the radio waves reflected from the object around the vehicle while transmitting the main chirp signal, mixing the main chirp signal with the second reflection chirp signal, and acquiring a second intermediate frequency signal in which the main chirp signal and the second reflection chirp signal are mixed.

The method may further include processing the second intermediate frequency signal, filtering the processed signal using the bin mask, and providing the object data including the information on the distance to the object and the moving speed of the object based on the filtered signal.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram for illustrating a configuration of a vehicle according to an embodiment of the present disclosure,

FIG. 2 is a conceptual view for illustrating examples of multiple fields of views of a camera and a radar included in an apparatus for driver assistance according to an embodiment of the present disclosure;

FIG. 3 is graphs for illustrating an example of radio waves transmitted by an apparatus for driver assistance according to an embodiment of the present disclosure;

FIG. 4 is a block diagram of a signal processing circuit included in an apparatus for driver assistance according to an embodiment of the present disclosure;

FIG. 5 is a conceptual diagram and graphs for illustrating an example of a transmission chirp signal and a reception chirp signal of an apparatus for driver assistance according to an embodiment of the present disclosure;

FIG. 6 is a view for illustrating an example of processing an intermediate frequency signal of an apparatus for driver assistance according to an embodiment of the present disclosure;

FIG. 7 is a graph for illustrating an example of a transmission chirp signal of an apparatus for driver assistance according to an embodiment of the present disclosure;

FIG. 8 is a conceptual diagram for illustrating an example for processing an intermediate frequency signal corresponding to a pre-chirp signal of an apparatus for driver assistance according to an embodiment of the present disclosure;

FIG. 9 is a conceptual diagram for illustrating an example of processing an intermediate frequency signal corresponding to a main chirp signal of an apparatus for driver assistance according to an embodiment of the present disclosure;

FIG. 10 is a conceptual diagram for illustrating an example for processing an intermediate frequency signal corresponding to a pre-chirp signal of an apparatus for driver assistance according to an embodiment of the present disclosure; and

FIG. 11 is a graph for illustrating an example of a transmission chirp signal of an apparatus for driver assistance according to an embodiment of the present disclosure.

### DETAILED DESCRIPTION OF EMBODIMENTS

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

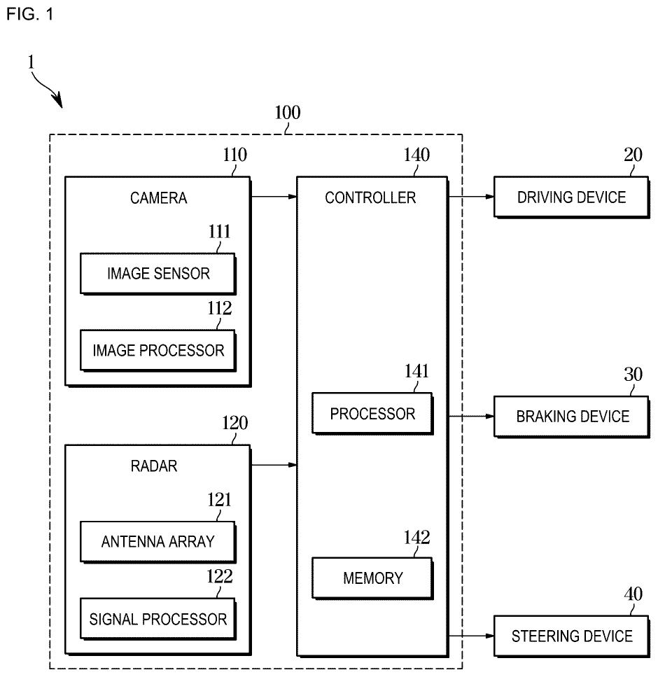

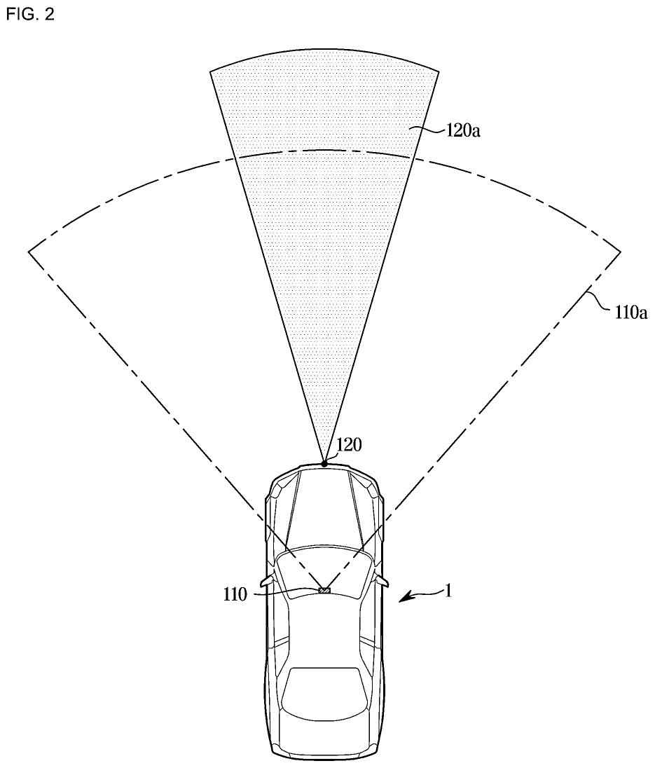

FIG. 1 is a block diagram for illustrating a configuration of a vehicle according to an embodiment of the present disclosure. FIG. 2 is a conceptual view for illustrating examples of multiple fields of views of a camera and a radar included in an apparatus for driver assistance according to an embodiment of the present disclosure.

As illustrated in FIG. 1, a vehicle 1 includes a driving device 20, a braking device 30, a steering device 40, and an apparatus 100 for driver assistance. The driving device 20, the braking device 30, the steering device 40, and/or the apparatus 100 for driver assistance may communicate with one another via a vehicle communication network. For example, the electric devices 20, 30, 40, and 100 included in the vehicle 1 may transmit or receive data via Ethernet, media oriented systems transport (MOST), Flexray, controller area network (CAN), local interconnect network (LIN), or the like.

The driving device 20 may move the vehicle 1 and include, for example, an engine, an engine management system (EMS), a transmission, and a transmission control unit (TCU). The engine may generate a power for the vehicle 1 to drive or travel, and the EMS may control the engine in response to a driver's acceleration intention through an accelerator pedal or a request or command of the apparatus 100 for driver assistance. The transmission may transmit the power generated by the engine to wheels for deceleration, and the TCU may control the transmission in response to a driver's transmission instruction through a transmission lever and/or a request or command of the apparatus 100 for driver assistance.

The braking device 30 may slow down or stop the vehicle 1 by applying brake to wheels and include, for example, a brake caliper and a brake control module (EBCM). The brake caliper may decelerate the vehicle 1 or stop the vehicle 1 using friction with a brake disc, and the EBCM may control the brake caliper in response to the driver's braking intention through a brake pedal and/or a request or command of the apparatus 100 for driver assistance. For example, the EBCM may receive a deceleration request or command including a deceleration from the apparatus 100 for driver assistance and electrically or hydraulically control the brake caliper so that the vehicle 1 decelerates depending on the requested deceleration.

The steering device 40 may include an electronic power steering control module (EPS). The steering device 40 may change a traveling direction of the vehicle 1, and the EPS may assist a driver's operation of the steering device 40 so that the driver may easily manipulate a steering wheel according to the driver's steering intention through the steering wheel. In addition, the EPS may control the steering device 40 in response to a request or command of the apparatus 100 for driver assistance. For example, the EPS may receive a steering request or command including a steering torque and/or direction from the apparatus 100 for driver assistance and control the steering device 40 to steer the vehicle 1 depending on the requested steering torque.

In addition, the apparatus 100 for driver assistance may communicate with the driving device 20, the braking device 30, and the steering device 40 via the vehicle communication network.

The apparatus 100 for driver assistance may provide various functions for safety to the driver. For example, the apparatus 100 for driver assistance may provide lane departure warning (LDW), lane keeping assist (LKA), high beam assist (HBA), autonomous emergency braking (AEB), traffic sign recognition (TSR), adaptive cruise control (ACC), blind spot detection (BSD), and the like, but not limited thereto.

The apparatus 100 for driver assistance may include, for example, but not limited to, one or more of a camera 110, a radar 120, and a controller 140. One or more of the camera 110, the radar 120, and the controller 140 may not be an essential component of the apparatus 100 for driver assistance. For example, at least one of the camera 110, the radar 120, or the controller 140 may be omitted from the apparatus 100 for driver assistance, and a detector (e.g., light detection and ranging (LiDAR)) capable of detecting objects around the vehicle 1 may also be added to the apparatus 100 for driver assistance.

The camera 110 may capture surroundings of the vehicle 1 and acquire image data of the surroundings of the vehicle 1. For example, as illustrated in FIG. 2, the camera 110 may be installed on a front windshield of the vehicle 1 and may have a field of view 110a outside the vehicle 1.

The camera 110 may include a plurality of lenses and an image sensor 111. For instance, the image sensor 111 may include a plurality of photodiodes for converting light into electrical signals, and the plurality of photodiodes may be arranged in the form of a two-dimensional matrix. The image sensor 111 may output image data including images of one or more objects around the vehicle 1.

The camera 110 may include an image processor 112 configured to process the image data. For example, the image processor 112 may process the image data to identify relative positions (e.g., distances from the vehicle 1 and angles with respect to the traveling direction of the vehicle 1) and classification (e.g., whether objects are other vehicles, pedestrians, cyclists, or the like) of objects of the vehicle 1. The image processor 112 may output first object data based on the processing of the image data. The first object data may include information on other vehicles, pedestrians, cyclists, or lane line markers (e.g. markers for distinguishing lanes) positioned around the vehicle 1.

The camera 110 may be electrically or communicationally connected to the controller 140. For example, the camera 110 may be connected to the controller 140 via the vehicle communication network or connected to the controller 140 via a hard wire or wireless communication. The camera 110 may transmit the first object data around the vehicle 1 to the controller 140.

The radar 120 may transmit transmission radio waves to the outside of the vehicle 1 and detect external objects around the vehicle 1 based on reflected radio waves reflected from the external objects. For example, as illustrated in FIG. 2, the radar 120 may be installed on a grille or bumper of the vehicle 1 and may have a sensing area or detection area 120a outside the vehicle 1.

The radar 120 may include an antenna array 121 including a transmission antenna TX (or a transmission antenna array) for radiating transmission radio waves to the surroundings of the vehicle 1 and a reception antenna RX (or a reception antenna array) for receiving reflected radio waves reflected from objects. The radar 120 may acquire radar data from the transmission radio waves transmitted by the transmission antenna TX and the reflected radio waves received by the reception antenna RX.

The radar 120 may include a signal processor 122 configured to process the radar data. The signal processor 122 may identify relative positions and relative velocities of the objects based on the radar data. The signal processor 122 may output second object data based on the processing of the radar data. The second object data may include position information (e.g., distance information) and/or speed information of the objects of the vehicle 1.

The radar 120 may be connected to the controller 140 via, for example, the vehicle communication network or the hard wire, and may transmit the radar data to the controller 140.

The controller 140 may be electrically or communicationally connected to the camera 110 and/or the radar 120. In addition, the controller 140 may be connected to the driving device 20, the braking device 30, and the steering device 40 via the vehicle communication network.

The controller 140 may process the first object data of the camera 110 and/or the second object data of the radar 120 and provide control signals to the driving device 20, the braking device 30, and/or the steering device 40.

The controller 140 may include a memory 142 and a processor 141.

The memory 142 may store programs, commands, instructions and/or data for processing the first object data of the camera 110 and/or the second object data of the radar 120. In addition, the memory 142 may store programs, commands, instructions and/or data for generating driving, braking, and steering signals.

The memory 142 may permanently or temporarily store the first object data received from the camera 110 and/or the second object data received from the radar 120 and permanently or temporarily store the results of processing the first object data and/or the second object data by the processor 141.

The memory 142 may include not only volatile memories such as a static random access memory (SRAM) and a dynamic RAM (DRAM) but also non-volatile memories such as a flash memory, a read only memory (ROM), and an erasable programmable ROM (EPROM).

The processor 141 may process the first object data of the camera 110 and/or the second object data of the radar 120. Based on the processing of the object data, the processor 141 may provide or generate a control signal, for example, but not limited to the driving signal, the braking signal, and/or the steering signal for controlling the driving device 20, the braking device 30, and/or the steering device 40, respectively. For example, the processor 141 may include a micro controller unit (MCU) configured to process the first object data of the camera 110 and/or the second object data of the radar 120 and generate the driving, braking, and steering signals.

The processor 141 may perform sensor fusion for detecting nearby objects of the vehicle 1 by fusing or combining the first object data of the camera 110 and the second object data of the radar 120. The processor 141 may output “object data” by performing the sensor fusion. For example, the processor 141 may match objects identified based on the second object data of the radar 120 with objects identified based on the first object data of the camera 110 and determine or identify classification, relative positions, and relative velocities of the nearby objects of the vehicle 1 based on the matched objects.

The processor 141 may calculate or evaluate risk of a collision between the vehicle 1 and at least one of the nearby objects based on the relative positions and relative velocities of the nearby objects of the vehicle 1. For example, the processor 141 may calculate a time to collision (TTC) (or a distance to collision (DTC)) between the vehicle 1 and the nearby object based on the position (distance) and relative speed of the nearby object of the vehicle 1 and evaluate the risk of collision between the vehicle 1 and the nearby object based on the TTC (or DTC). The processor 141 may determine that the shorter the TTC, the higher the risk of collision.

The processor 141 may select a target object among the nearby objects of the vehicle 1 based on the risk of collision. For example, the processor 141 may select the target object based on the TTCs between the vehicle 1 and the nearby objects.

The processor 141 may generate a control signal such as the driving signal, the braking signal, or the steering signal based on the risk of a collision with the target object. For example, the processor 141 may warn a driver of a collision or transmit the braking signal to the braking device 30 based on a comparison between a reference time and the TTC between the vehicle 1 and the target object. In addition, the processor 141 may transmit the steering signal to the steering device 40 in order to avoid the collision with the target object based on the comparison between a reference time and the TTC between the vehicle 1 and the target object.

Hereinafter, configurations and operations of the radar 120 and the signal processor 122 will be described in more detail.

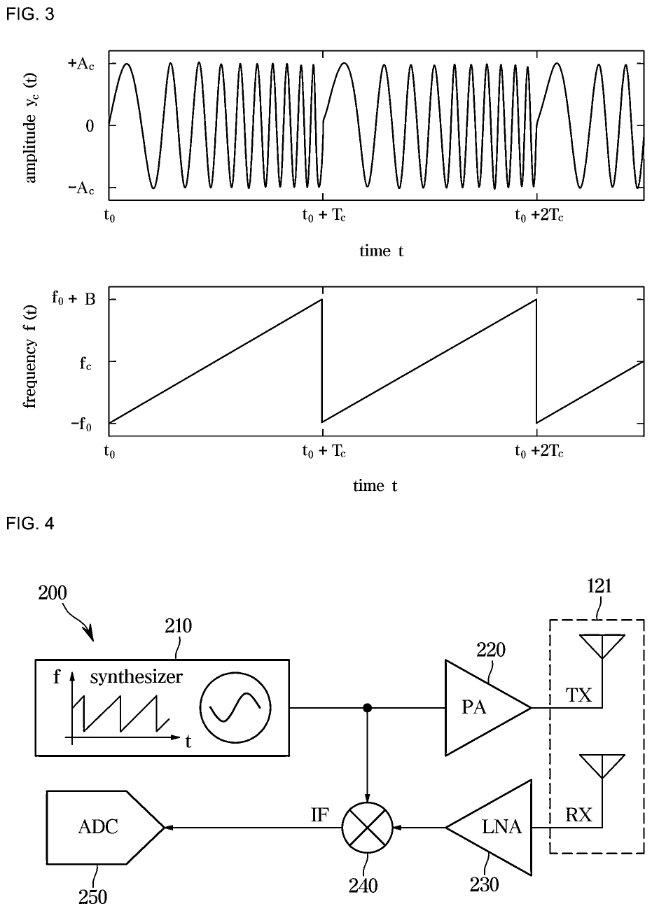

FIG. 3 is graphs for illustrating an example of radio waves transmitted by an apparatus for driver assistance according to an embodiment of the present disclosure.

The radar 120 may include, for example, a frequency-modulated continuous-wave (FMCW) type radar for transmitting a series of linear chirps.

The FMCW type radar 120 may transmit the chirps through the antenna array 121. The chirp may include a signal (e.g. a sine wave or a sinusoidal wave) in which frequency increases or decreases with time.

For example, as illustrated in FIG. 3, a linear chirp may include a sine wave or a sinusoidal wave in which frequency linearly increases or decreases with time.

A frequency of the linear chirp illustrated in FIG. 3 can be expressed as Equation 1.

$$\\ \begin{matrix}f ( t ) = {f}_{0} + \frac{B}{{T}_{c}} ( t - {t}_{0} ) = {f}_{0} + S ( t - {t}_{0} ) & [ Equation 1 ]\end{matrix}$$

Here, f₀ denotes a start frequency at a time point to, B denotes a modulation width (e.g., bandwidth) of a frequency, and T_{c} denotes a frequency modulation time of the linear chirp. S denotes a frequency change rate or a frequency slope.

In addition, since a derivative of a time with respect to a phase ϕ is an angular frequency, a function corresponding to a phase of a transmission signal may be an integral of a frequency function. Therefore, a change in the phase ϕ of the chirp can be expressed as Equation 2.

ϕ(t+Δt)≃ϕ(t)+2πf(t)Δt [Equation 2]

Here, ϕ denotes a phase of the linear chirp, and f(t) denotes a frequency of the linear chirp.

Using Equation 2, the phase ϕ of the linear chirp can be expressed as Equation 3.

$$\\ \begin{matrix}ϕ ( t ) = {ϕ}_{0} + 2 π {\int }_{{t}_{0}}^{t} f ( τ ) d τ = {ϕ}_{0} + 2 π [ {f}_{0} ( t - {t}_{0} ) + \frac{B}{2 {T}_{c}} ( {t}^{2} - {t}_{0}^{2} ) ] & [ Equation 3 ]\end{matrix}$$

Here, ϕ denotes the phase of the linear chirp, and f(t) denotes the frequency of the linear chirp. t₀ denotes a start time, f₀ denotes a start frequency, and ϕ₀ denotes an initial phase. In addition, B denotes a bandwidth of the linear chirp, and T_{c} denotes a modulation time of the linear chirp.

Using Equation 3, the phase ϕ with respect to the time can be expressed as Equation 4.

$$\\ \begin{matrix}{y}_{c} ( t ) = {v}_{TX} ( t ) = {A}_{c} sin ( {ϕ}_{0} + 2 π {f}_{0} t + π \frac{B}{{T}_{c}} {( t - {mT}_{c} )}^{2} ) & [ Equation 4 ]\end{matrix}$$

Here, y_{c} denotes a linear chirp function, A_{c} denotes an amplitude of the linear chirp, and m denotes an m^{th} chirp.

As illustrated in FIG. 3, the radar 120 may transmit the linear chirp expressed as Equation 4.

A transmission chirp transmitted from the radar 120 may be mixed with a reception chirp reflected from an object. The reception chirp may be attenuated and delayed while being reflected from the object and propagated.

Due to such a time delay, a frequency of the reception chirp may be different from a frequency of the transmission chirp. Since the frequency of the transmission chirp linearly varies over time, the frequency of the reception chirp delayed during reflection may be different from the frequency of the transmission chirp. In addition, a difference between the frequency of the transmission chirp and the frequency of the reception chirp may be proportional to a distance between the vehicle 1 and a reflective object.

The signal processor 122 of the radar 120 may identify the distance between the vehicle 1 and the reflective object based on the difference between the frequency of the transmission chirp and the frequency of the reception chirp.

FIG. 4 is a block diagram of a signal processing circuit included in an apparatus for driver assistance according to an embodiment of the present disclosure.

The radar 120 may further include a signal processing circuit 200 configured to process an analog signal received by the antenna array 121.

The signal processing circuit 200 may acquire an intermediate frequency signal representing the difference between the frequency of the transmission chirp and the frequency of the reception chirp based on the processing of the analog signal. The signal processing circuit 200 may convert the acquired intermediate frequency signal into a digital signal and provide the digitalized intermediate frequency signal to the signal processor 122.

The signal processing circuit 200 may include a synthesizer 210, a power amplifier (PA) 220, a low noise amplifier (LNA) 230, a frequency mixer 240, and/or an analog-to-digital converter (ADC) 250. At least one of the synthesizer 210, the power amplifier 220, the low noise amplifier 230, the frequency mixer 240, and the ADC 250 may not be essential components of the signal processing circuit 200, and at least one thereof may be omitted.

The synthesizer 210 may generate a linear chirp signal in which a plurality of linear chirps are consecutive. The chirp signal generated by the synthesizer 210 can be expressed as the above-described Equation 4.

The power amplifier 220 may amplify the chirp signal generated by the synthesizer 210.

The amplified chirp signal may be transmitted by the transmission antenna TX (or the transmission antenna array) of the antenna array 121. In addition, the reception antenna RX (or the reception antenna array) of the antenna array 121 may receive the chirp signal reflected from the object.

The low noise amplifier 230 may amplify the chirp signal received by the reception antenna RX.

The frequency mixer 240 may mix the transmission chip signal (e.g. the chirp signal generated by the synthesizer 210) with the reception chirp signal (e.g. the chirp signal received by the reception antenna RX). The frequency mixer 240 may output an intermediate frequency signal (IF) by mixing the transmission chirp signal with the reception chirp signal. The intermediate frequency signal output from the frequency mixer 240 may include information on the object.

The ADC 250 may convert the intermediate frequency signal output from the frequency mixer 240 into a digital signal and provide the converted digital signal to the signal processor 122.

The signal processor 122 may receive the digital signal representing the intermediate frequency signal from the ADC 250 and process the received digital signal.

The signal processor 122 may identify a distance to the reflective object from the vehicle 1 and a moving speed of the reflective object based on the processing of the digital signal.

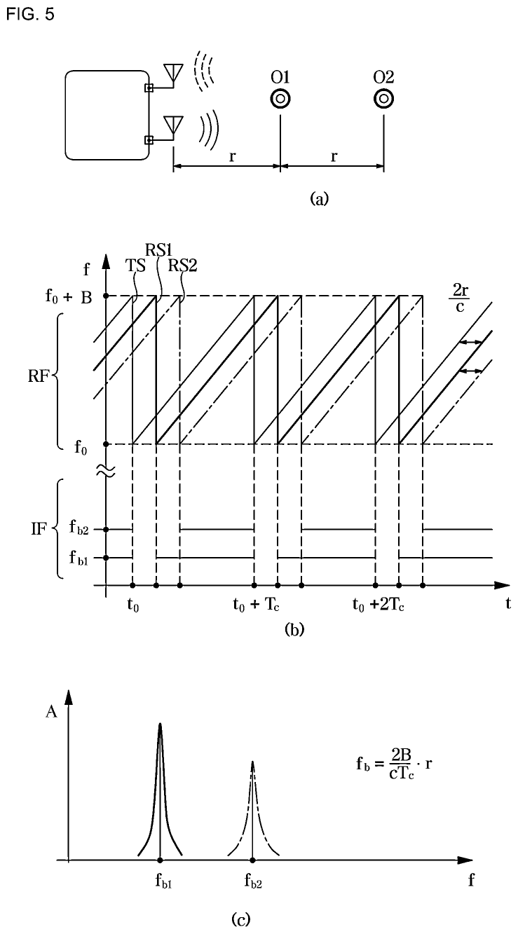

FIG. 5 is a conceptual diagram and graphs for illustrating an example of a transmission chirp signal and a reception chirp signal of an apparatus for driver assistance according to an embodiment of the present disclosure.

Since a frequency of a signal (e.g. an intermediate frequency signal) mixed by the frequency mixer 240 is a frequency corresponding to a difference between instantaneous frequencies and the reception chirp signal is the delayed signal of the transmission chirp signal generated by the synthesizer 210, the intermediate frequency signal may include a frequency component proportional to the delay of the reception chirp signal.

For example, as illustrated in FIGS. 5(a) and 5(b), a transmission chirp signal TS transmitted from the antenna array 121 may be reflected from a first object O1 and a second object O2. The antenna array 121 may receive a first reception chirp signal RS1 reflected from the first object O1 and a second reception chirp signal RS2 received by the second object O2.

In FIG. 5(c), a frequency of a mixed signal of the transmission chirp signal TS and the first reception chirp signal RS1 may be a first intermediate frequency f_{b1}, and a frequency of a mixed signal of the transmission chirp signal TS and the second reception chirp signal RS2 may be a second intermediate frequency f_{b2}.

The frequency of the mixed signal may correspond to a delay between the transmission chirp signal and the reception chirp signal. Specifically, the frequency of the mixed signal can be expressed as Equation 5.

$$\\ \begin{matrix}{f}_{b} = \frac{2 rS}{c} = \frac{2 B}{{cT}_{c}} \cdot r & [ Equation 5 ]\end{matrix}$$

Here, f_{b} denotes a frequency of the mixed signal, r denotes a distance to the reflective object, c denotes a speed of light, and S denotes a frequency slope of the transmission chirp signal. In addition, T_{c} denotes a modulation time, and B denotes a bandwidth of the transmission chirp signal.

The delay between the transmission chirp signal and the reception chirp signal may be equal to a round-trip delay time to the object. In addition, a difference between the frequency of the transmission chirp signal and the frequency of the reception chirp signal may correspond to the round-trip delay time.

The distance r to the object can be expressed as Equation 6.

$$\\ \begin{matrix}r = \frac{{cf}_{b}}{2 S} = \frac{{cT}_{c}}{2 B} \cdot {f}_{b} & [ Equation 6 ]\end{matrix}$$

Here, r denotes the distance to the reflective object, c denotes the speed of light, and S denotes the frequency slope of the transmission chirp signal. T_{c} denotes the modulation time, B denotes the bandwidth of the transmission chirp signal, and f_{b} denotes the intermediate frequency of the signal mixed by the frequency mixer 240.

In addition, initial phases of all components of the intermediate frequency signal may be a difference between a phase of the transmission chirp signal and a phase of the reception chirp signal at the start of the intermediate frequency signal.

The radar 120 may consecutively transmit a plurality of chirp signals at uniform intervals in order to identify a moving speed of a moving object.

While the object is moving, a distance measurement through the round-trip delay of the chirp signal is affected by compression or elongation of a signal known as the Doppler effect.

Spatial displacement of the object may occur due to the movement of the object while the plurality of chirp signals are consecutively transmitted.

The spatial displacement of the object may affect both the frequency and phase of the intermediate frequency signal by the plurality of chirp signals. The spatial displacement of the object may lead to a change in the round-trip delay of the chirp signal. The spatial displacement of the object does not affect the initial phase of the transmission chirp signal but affects a current phase of the reception chirp signal, and thus may affect the phase of the intermediate frequency signal.

A phase difference of the intermediate frequency signal can be expressed as Equation 7.

$$\\ \begin{matrix}Δ ϕ = 2 π {f}_{0} Δ t = 2 π {f}_{0} \frac{2 Δ d}{c} = \frac{4 π}{{λ}_{0}} \cdot Δ d & [ Equation 7 ]\end{matrix}$$

Here, Δϕ denotes a phase difference of the intermediate frequency signal, f₀ denotes a start frequency of the chirp signal, λ₀ denotes a wavelength of the chirp signal, Δt denotes a change in the round-trip delay of the chirp signal, and Δd denotes a change in the round-trip distance, that is, the spatial displacement of the object.

When the object moves by Δd for the modulation time T_{c}, the speed of the moving object can be expressed as Equation 8.

$$\\ \begin{matrix}v = \frac{{λ}_{0}}{4 π {T}_{c}} \cdot Δ ϕ & [ Equation 8 ]\end{matrix}$$

Here, v denotes a speed of the moving object, λ₀ denotes the wavelength of the chirp signal, T_{c} denotes the modulation time, and Δϕ denotes the phase difference of the intermediate frequency signal.

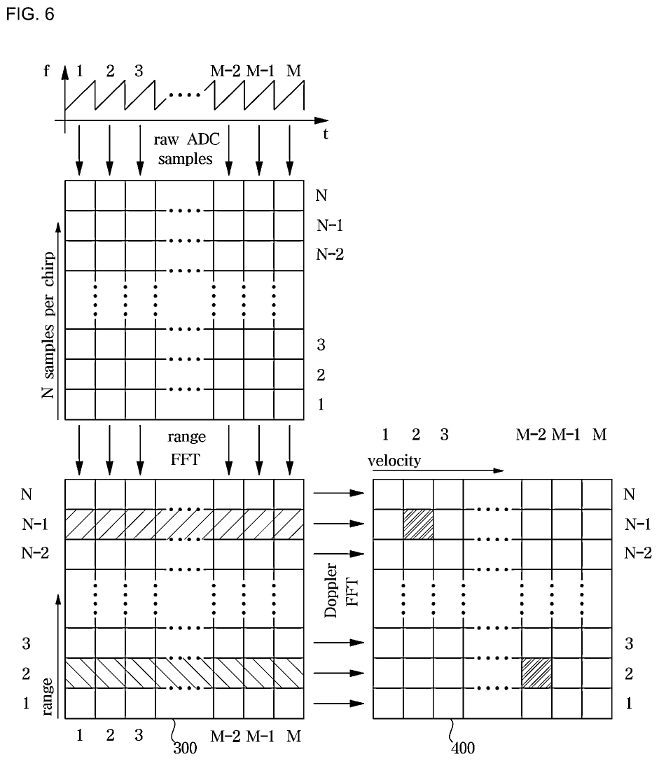

FIG. 6 is a view for illustrating an example of processing an intermediate frequency signal of an apparatus for driver assistance according to an embodiment of the present disclosure.

The signal processor 122 may process the digitized intermediate frequency signal using fast Fourier transform (FFT). The signal processor 122 may determine or identify the intermediate frequency f_{b} of the intermediate frequency signal and the phase difference Δϕ of the intermediate frequency signal using the FFT. In addition, the signal processor 122 may identify the distance to the object based on the intermediate frequency f_{b} of the intermediate frequency signal and the moving speed of the object based on the phase difference Δϕ of the intermediate frequency signal.

The radar 120 may transmit the chirp signal including the plurality of chirps in order to identify the distance to the object and the moving speed of the object. For example, as illustrated in FIG. 6, the radar 120 may transmit a signal including M chirps.

The ADC 250 may sample the intermediate frequency signal N times while each chirp is transmitted, and convert the sampled analog signal into a digital signal.

The signal processor 122 may transform the intermediate frequency signal digitized by the ADC 250 into a frequency domain signal through the FFT. Specifically, the signal processor 122 may transform an intermediate frequency signal corresponding to one chirp into a frequency domain signal through the FFT.

For example, as illustrated in FIG. 6, the signal processor 122 may transform an intermediate frequency signal corresponding to each of the M chirps into a frequency domain signal through the FFT. When acquiring N pieces of sampling data of the intermediate frequency signal corresponding to one chirp, the signal processor 122 may transform the acquired sampling data into the frequency domain signal through the FFT. Therefore, the signal processor 122 may store only the N pieces of sampling data, and less memory space can be used for storing the sampling data.

Hereinafter, the transforming of the intermediate frequency signal corresponding to each of the M chirps into the frequency domain signal through the FFT is referred to as a “range FFT.”

The signal processor 122 may acquire a frequency domain matrix 300 having peaks at intermediate frequencies f_{b1} and f_{b2} corresponding to the distances to the reflective objects as illustrated in FIG. 5 by performing the range FFT on the intermediate frequency signal corresponding to each of the M chirps. As described above, due to the frequency difference between the transmission chirp signal and the reception chirp signal caused by the delay of the reception chirp signal, the intermediate frequency signal having the peaks at the intermediate frequencies f_{b1} and f_{b2} may be acquired, and the frequency domain matrix 300 having the peaks at the intermediate frequencies f_{b1} and f_{b2} may be acquired.

Then, as illustrated in FIG. 6, the signal processor 122 may transform data of the frequency domain matrix 300, which has been acquired after performing the range FFT, through the FFT. Specifically, the signal processor 122 may transform a series of data, which correspond to the same frequency in the frequency domain matrix 300, through the FFT.

Hereinafter, the transforming of the series of data corresponding to the same frequency through the FFT is referred to as a “Doppler FFT.”

The signal processor 122 may acquire a phase domain matrix 400 having a peak at the phase difference Δϕ corresponding to the moving speed of the reflective object as illustrated in FIG. 6 by performing the Doppler FFT. As described above, the phase difference Δϕ may occur between the M reception chirp signals due to the movement of the object, and the phase domain matrix 400 having the peak at each frequency corresponding to the phase difference Δϕ may be acquired by the Doppler FFT performed on the frequency domain matrix 300.

The signal processor 122 may acquire the frequency domain matrix 300 by performing the range FFT on the intermediate frequency signal generated by the frequency mixing of the transmission chirp signal and the reception chirp signal. In addition, the signal processor 122 may acquire the phase domain matrix 400 by performing the Doppler FFT on the frequency domain matrix 300.

As described above, the range FFT may be performed on the sampling data sampled at the same chirp, and the Doppler FFT may be performed on the series of data corresponding to the same frequency. For example, as illustrated in FIG. 6, the range FFT may be performed on data in the same column, and the Doppler FFT may be performed on data in the same row.

Hereinafter, the performing of the range FFT on the data in the same column and the performing of the Doppler FFT on the data in the same row are collectively referred to as a “2-dimension FFT” The signal processor 122 may sample the N intermediate frequency signals and store the sampled signals to perform the range FFT. At this time, since the range FFT is performed on N sampling data corresponding to one chirp, a memory may store the N sampling data.

On the other hand, since the Doppler FFT is performed on the series of data corresponding to the same frequency of the frequency domain matrix 300 generated by performing the range FFT, N frequency data are required for all M chirps to perform the Doppler FFT. Therefore, a memory capable of storing M×N frequency data may be used to perform the Doppler FFT.

The radar 120 may transmit a pre-chirp signal to use less memory space for storing the frequency data.

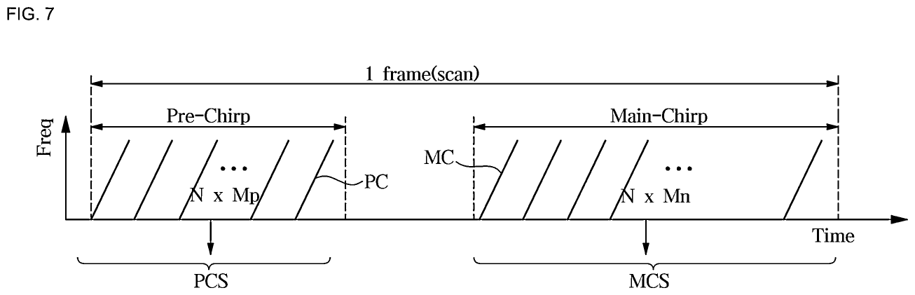

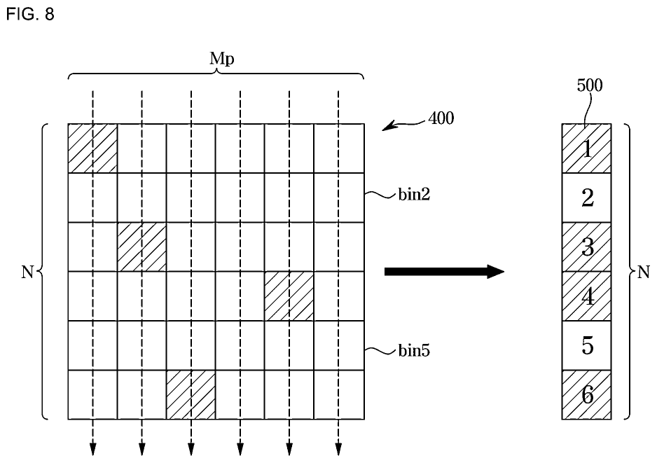

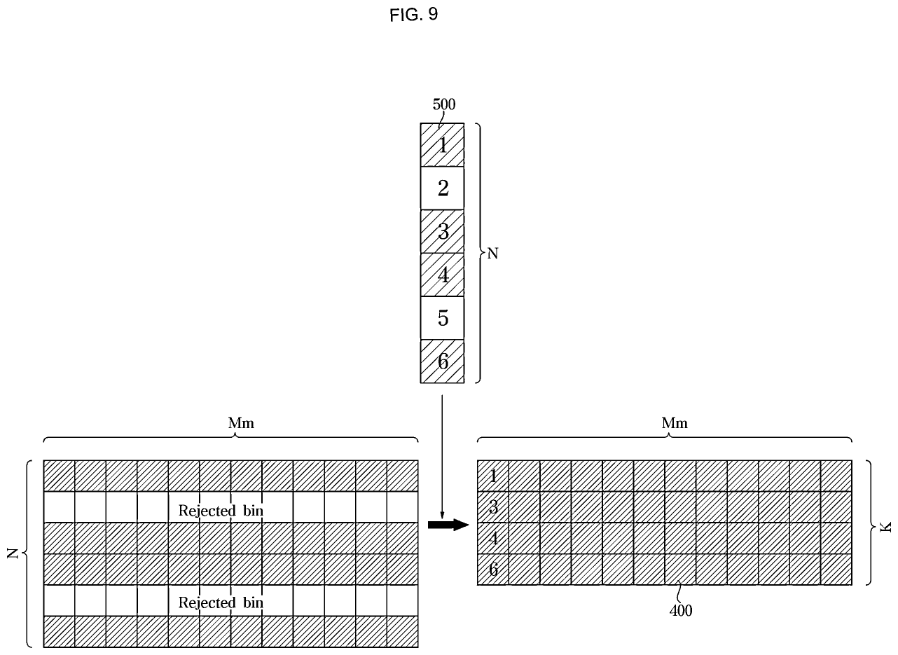

FIG. 7 is a graph for illustrating an example of a transmission chirp signal of an apparatus for driver assistance according to an embodiment of the present disclosure. FIG. 8 is a conceptual diagram for illustrating an example for processing an intermediate frequency signal corresponding to a pre-chirp signal of an apparatus for driver assistance according to an embodiment of the present disclosure. FIG. 9 is a conceptual diagram for illustrating an example of processing an intermediate frequency signal corresponding to a main chirp signal of an apparatus for driver assistance according to an embodiment of the present disclosure.

As illustrated in FIG. 7, the radar 120 may transmit a pre-chirp signal PCS and a main chirp signal MCS. For example, the signal processing circuit 200 may generate or provide the pre-chirp signal PCS and the main chirp signal MCS to the antenna array 121, and the antenna array 121 may transmit radio waves corresponding to the pre-chirp signal PCS and radio waves corresponding to the main chirp signal MCS. Hereinafter, the radio waves corresponding to the pre-chirp signal PCS and the radio waves corresponding to the main chirp signal MCS may be referred to as “pre-chirp signal PCS” and “main chirp signal MCS,” respectively.

The pre-chirp signal PCS may include Mp consecutive pre-chirps PC, and the main chirp signal MCS may include Mm consecutive main chirps MC. The number of pre-chirps PC included in the pre-chirp signal PCS may be smaller than the number of main chirps MCs included in the main chirp signal MCS.

The radar 120 may transmit the pre-chirp signal PCS before transmitting the main chirp signal MCS.

While the pre-chirp signal PCS is transmitted, the signal processor 122 may acquire N pieces of sampling data on an intermediate frequency signal corresponding to each of the Mp pre-chirps PCs.

The signal processor 122 may perform the range FFT on N pieces of sampling data of an intermediate frequency signal corresponding to one pre-chirp PC. The signal processor 122 may acquire an Mp×N frequency domain matrix 300 by the range FFT.

The signal processor 122 may perform the Doppler FFT on data corresponding to the same frequency in the Mp×N frequency domain matrix 300. The signal processor 122 may acquire an Mp×N phase domain matrix 400 by the Doppler FFT as illustrated in FIG. 8.

The signal processor 122 may identify a distance to an object positioned within the sensing area of the radar 120 and a moving speed of the object based on peaks of the Mp×N phase domain matrix 400.

As illustrated in FIG. 8, the signal processor 122 may apply a constant false alarm rate detection (CFAR) algorithm or a local maximum algorithm to data corresponding to one pre-chirp of the Mp×N phase domain matrix 400.

The signal processor 122 may identify a distance at which each of the objects detected by the CFAR algorithm or the local maximum algorithm is positioned. In addition, the signal processor 122 may identify a distance at which no object is present, that is, a row in which no object data is present in the Mp×N phase domain matrix 400.

Each row of the frequency domain matrix 300 and each row of the phase domain matrix 400 may include a series of data corresponding to the same intermediate frequency. Therefore, the same row of the frequency domain matrix 300 and the same row of the phase domain matrix 400 may each represent the same distance.

Hereinafter, a series of data (e.g., each row in the matrix illustrated in FIG. 8) representing the same distance in the frequency domain matrix 300 and the phase domain matrix 400 is referred to as “bin.”

The signal processor 122 may identify a bin in which no object data is present in the Mp×N phase domain matrix 400. For example, the signal processor 122 may identify that no object data is present in a second bin bin2 and a fifth bin bin5 from the top of the phase domain matrix 400 illustrated in FIG. 8.

The signal processor 122 may generate a bin mask 500 for ignoring, removing, missing, or filtering data of the second bin bin2 and the fifth bin bin5 in order to remove bins not including the object data.

The radar 120 may transmit the main chirp signal MCS after transmitting the pre-chirp signal PCS.

While the main chirp signal MCS is transmitted, the signal processor 122 may acquire N pieces of sampling data on an intermediate frequency signal corresponding to each of Mm main chirps MCs.

The signal processor 122 may perform the range FFT on N pieces of sampling data of an intermediate frequency signal corresponding to one main chirp MC.

While performing the range FFT, the signal processor 122 may ignore, remove, omit, or filter the data of the bins not including the object data using the bin mask 500 and store only data of bins including the object data.

For example, as illustrated in FIG. 8, the signal processor 122 may include the bin mask 500 for ignoring, removing, or missing the second bin bin2 and the fifth bin bin5. Since the signal processor 122 may apply the bin mask 500 to a series of data output by the range FFT, the data of the second bin bin2 and the data of the fifth bin bin5 among the data output by the range FFT may be ignored, removed, or missed as illustrated in FIG. 9.

The signal processor 122 may acquire an Mm×K frequency domain matrix 300 by the range FFT. Here, “K” denotes the number of bins after being ignored, removed, or missed by the bin mask 500. In addition, the number of bins K after being ignored, removed, or missed may be less than the number of pieces of sampling data N.

As described above, less memory space for storing the frequency domain matrix 300 can be used by ignoring, removing, or missing the data of the bins not including the object data.

In addition, the signal processor 122 may perform the Doppler FFT on data corresponding to the same frequency in the Mm×K frequency domain matrix 300. The signal processor 122 may acquire an Mm×K phase domain matrix 400 by the Doppler FFT.

The signal processor 122 may identify a distance to an object positioned within the sensing area of the radar 120 and a moving speed of the object based on peaks of the Mm×K phase domain matrix 400.

As described above, the radar 120 may consecutively transmit the pre-chirp signal PCS and the main chirp signal MCS. In this case, the number of chirps of the pre-chirp signal PCS may be less than the number of chirps of the main chirp signal MCS.

The radar 120 may identify the distance to the object positioned within the sensing area of the radar 120 and the moving speed of the object based on the intermediate frequency signal by the pre-chirp signal PCS. The radar 120 may identify the bins not including the object data in the phase domain matrix 400 based on the intermediate frequency signal by the pre-chirp signal PCS and generate or provide the bin mask 500 for ignoring, removing, or missing the data of the bins not including the object data.

The radar 120 may identify the distance to the object positioned within the sensing area of the radar 120 and the moving speed of the object based on the intermediate frequency signal by the main chirp signal MCS. While identifying the objects, the radar 120 may ignore, remove, or miss the bins not including the object data in a data matrix for processing the intermediate frequency signal using the bin mask 500.

Therefore, the radar 120 can reduce the size of the data matrix for processing the intermediate frequency signal and also use less memory space for storing the data matrix. In addition, the resource and amount of calculation of the signal processor 122 for processing the data matrix can be reduced.

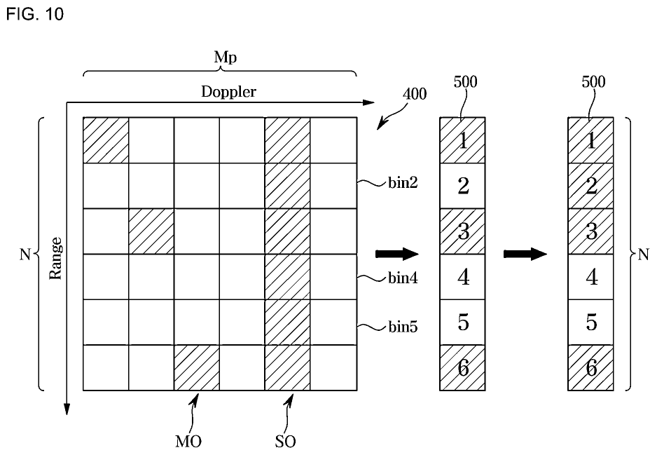

FIG. 10 is a conceptual diagram for illustrating an example for processing an intermediate frequency signal corresponding to a pre-chirp signal of an apparatus for driver assistance according to an embodiment of the present disclosure.

In the case of a moving object MO, peaks may appear at a specific distance and a specific speed after performing the 2-dimensional FFT.

On the other hand, the phase domain matrix 400 in which peaks corresponding to the same speed are listed according to distances by structures around a road may be acquired. For example, as illustrated in FIG. 10, peaks corresponding to the same speed may be listed according to the distance by a stopped object SO. Therefore, the size of the phase domain matrix 400 cannot be reduced.

As described above, when the structures around the road are detected, a magnitude of the moving speed of the detected object may be the same as a traveling speed of the vehicle 1. That is, in the phase domain matrix 400, peaks corresponding to the same speed as the magnitude of the traveling speed of the vehicle 1 may be listed according to the distances.

As described above, when the peaks corresponding to the same speed as the magnitude of the traveling speed of the vehicle 1 are listed according to the distances in the phase domain matrix 400, the radar 120 may generate the bin mask 500 without considering data of the stopped object SO. That is, the radar 120 may generate the bin mask 500 based on data of the moving object MO only, not the data of the stopped object SO.

Then, the radar 120 may correct the bin mask 500 based on the data of the stopped object SO (e.g., the peaks representing the same speed). That is, the radar 120 may correct the bin mask 500 based on the closest distance among the distances detected by the data of the stopped object SO.

For example, as illustrated in FIG. 10, the radar 120 may generate the bin mask 500 for ignoring, removing, missing, or filtering data of a second bin bin2, a fourth bin bin4, and a fifth bin bin5 based on the data of the moving object MO. Then, the radar 120 may determine that the data of the stopped object SO is present in the second bin bin2 having the closest distance from the vehicle 1 based on the data of the stopped object SO. The radar 120 may generate the bin mask 500 for ignoring, removing, missing, or filtering data of the fourth bin bin4 and the fifth bin bin5 based on both the data of the moving object MO and the data of the stopped object SO.

Therefore, it is possible to prevent or suppress the detection of non-movable structures around the road from interfering with operation of reducing the size of the phase domain matrix 400.

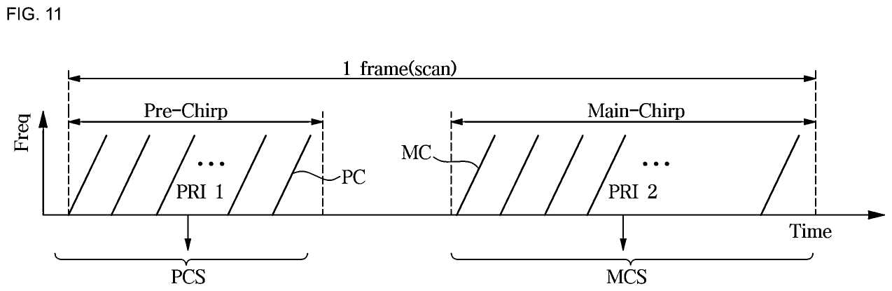

FIG. 11 is a graph for illustrating an example of a transmission chirp signal of an apparatus for driver assistance according to an embodiment of the present disclosure.

As illustrated in FIG. 11, the radar 120 may sequentially transmit the pre-chirp signal PCS and the main chirp signal MCS.

The pre-chirp signal PCS may include Mp consecutive pre-chirps PCs, and the main chirp signal MCS may include Mm consecutive main chirps MCs. In this case, the number of pre-chirps PCs included in the pre-chirp signal PCS may be less than the number of main chirps MCs included in the main chirp signal MCS.

The Mp consecutive pre-chirps PCs of the pre-chirp signal PCS and the Mm consecutive main chirps MCs of the main chirp signal MCS are each transmitted at a predetermined pulse repetition interval PRI. In this case, the PRI at which the pre-chirps PCs are transmitted may be different from the PRI at which the main chirps MCs are transmitted. For example, the pre-chirps PCs may be transmitted at a first PRI, and the main chirps MCs may be transmitted at a second PRI which is different from the first PRI.

That is, a modulation time T_{c} of the pre-chirp PC may be different from a modulation time T_{c} of the main chirp MC. Therefore, a frequency slope S at which a frequency of the pre-chirp PC varies may be different from a frequency slope S at which a frequency of the main chirp MC varies.

As described above, since the first PRI of the pre-chirp PC is different from the second PRI of the main chirp MC, Doppler ambiguity can be resolved.

As is apparent from the above description, an apparatus for driver assistance including a radar and a method of controlling the same according to some embodiments of the present disclosure may reduce the amount of data stored in the memory and reduce the calculation of data performed by the processor.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above-described exemplary embodiments, embodiments can thus be implemented through computer readable code/instructions in/on a medium, e.g., a computer readable medium, to control at least one processing element to implement any above-described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A radar system comprising:
a radar installed to a vehicle, and configured to generate object data by sensing an object around the vehicle; and
a controller configured to identify a distance to the object from the vehicle and a moving speed of the object based on the object data of the radar,
wherein the radar comprises:
an antenna array;
a signal processing circuit configured to provide a transmission signal to the antenna array to transmit transmission radio waves through the antenna array and acquire a reception signal corresponding to reception radio waves received by the antenna array; and
a signal processor configured to control the signal processing circuit to provide a pre-chirp signal including a plurality of pre-chirps and a main chirp signal including a plurality of main chirps to the antenna array, wherein a number of the pre-chirps included in the pre-chirp signal is less than a number of the main chirps included in the main chirp signal.

2. The radar system of claim 1, wherein the antenna array is configured to:
sequentially transmit radio waves corresponding to the pre-chirp signal and radio waves corresponding to the main chirp signal; and
receive radio waves reflected from the object.

3. The radar system of claim 2, wherein the signal processing circuit is configured to:
acquire a first reflection chirp signal corresponding to radio waves reflected from the object while transmitting the pre-chirp signal;
mix the pre-chirp signal with the first reflection chirp signal; and
provide a first intermediate frequency signal in which the pre-chirp signal and the first reflection chirp signal are mixed to the signal processor.

4. The radar system of claim 3, wherein the signal processor is configured to:
generate the object data including information on the distance to the object and the moving speed of the object based on the first intermediate frequency signal in which the pre-chirp signal and the first reflection chirp signal are mixed; and
generate a bin mask indicating which one or more bins do not include data corresponding to the distance to the object.

5. The radar system of claim 1, wherein the signal processor is configured to:
transform a plurality of first intermediate frequency signals corresponding to the plurality of pre-chirps into a plurality of pieces of first frequency domain data through a fast Fourier transform, respectively, wherein each of the first intermediate frequency signals is generated by mixing the pre-chirp signal and a first reflection chirp signal corresponding to radio waves reflected from the object while transmitting the pre-chirp signal; and
store a first frequency domain matrix including the plurality of pieces of first frequency domain data.

6. The radar system of claim 5, wherein the signal processor is configured to:
transform one or more pieces of the first frequency domain data corresponding to a same frequency among the plurality of pieces of first frequency domain data into a plurality of pieces of first phase domain data through the fast Fourier transform; and
store a first phase domain matrix including the plurality of pieces of first phase domain data.

7. The radar system of claim 6, wherein the signal processor is configured to provide the object data including information on the distance to the object and the moving speed of the object based on the plurality of pieces of first phase domain data included in the first phase domain matrix.

8. The radar system of claim 7, wherein:
the first phase domain matrix comprises a plurality of first bins corresponding to different distances, and
the signal processor is configured to provide a bin mask indicating which one or more bins do not include data corresponding to the distance to the object among the plurality of first bins.

9. The radar system of claim 4, wherein the signal processing circuit is configured to:
acquire a second reflection chirp signal corresponding to radio waves reflected from the object while transmitting the main chirp signal;
mix the main chirp signal with the second reflection chirp signal; and
provide a second intermediate frequency signal in which the main chirp signal and the second reflection chirp signal are mixed to the signal processor.

10. The radar system of claim 9, wherein the signal processor is configured to:
process the second intermediate frequency signal in which the main chirp signal and the second reflection chirp signal are mixed;
filter the processed second intermediate frequency signal using the bin mask indicating which one or more bins do not include the data corresponding to the distance to the object; and
provide the object data including the information on the distance to the object and the moving speed of the object based on the filtered second intermediate frequency signal.

11. The radar system of claim 4, wherein the signal processor is configured to:
transform a plurality of second intermediate frequency signals corresponding to the plurality of pre-chirps into a plurality of pieces of second frequency domain data through a fast Fourier transform, respectively, wherein each of the plurality of second intermediate frequency signals is generated by mixing the main chirp signal and a second reflection chirp signal corresponding to radio waves reflected from the object while transmitting the main chirp signal;
filter data corresponding to the one or more bins among the plurality of pieces of second frequency domain data using the bin mask indicating which one or more bins do not include data corresponding to the distance to the object; and
store a second frequency domain matrix including the plurality of pieces of the filtered data corresponding to the one or more bins.

12. The radar system of claim 11, wherein the signal processor is configured to:
transform data corresponding to a same frequency among the plurality of pieces of the filtered data corresponding to the one or more bins into a plurality of pieces of second phase domain data through the fast Fourier transform; and
store a second phase domain matrix including the plurality of pieces of second phase domain data.

13. The radar system of claim 12, wherein the signal processor is configured to provide the object data including the information on the distance to the object and the moving speed of the object based on the plurality of pieces of second phase domain data included in the second phase domain matrix.

14. The radar system of claim 1, wherein a frequency slope of each of the plurality of pre-chirps is different from a frequency slope of each of the plurality of main chirps.

15. A method of controlling an apparatus including an antenna array installed to a vehicle, the method comprising:
providing a pre-chirp signal including a plurality of pre-chirps and a main chirp signal including a plurality of main chirps to the antenna array;
sequentially transmitting, by the antenna array, radio waves corresponding to the pre-chirp signal and radio waves corresponding to the main chirp signal; and
receiving, by the antenna array, radio waves reflected from an object around the vehicle,
wherein the number of the pre-chirps included in the pre-chirp signal is smaller than the number of the main chirps included in the main chirp signal.

16. The method of claim 15, further comprising:
acquiring a first reflection chirp signal corresponding to the radio waves reflected from the object while transmitting the pre-chirp signal; and
mixing the pre-chirp signal with the first reflection chirp signal to generate a first intermediate frequency signal in which the pre-chirp signal and the first reflection chirp signal are mixed.

17. The method of claim 16, further comprising:
generating object data including information on a distance to the object and a moving speed of the object based on the first intermediate frequency signal in which the pre-chirp signal and the first reflection chirp signal are mixed; and
generating a bin mask indicating which one or more bins do not include data corresponding to the distance to the object.

18. The method of claim 17, further comprising:
acquiring a second reflection chirp signal corresponding to the radio waves reflected from the object while transmitting the main chirp signal;
mixing the main chirp signal with the second reflection chirp signal to generate a second intermediate frequency signal in which the main chirp signal and the second reflection chirp signal are mixed.

19. The method of claim 18, further comprising:
processing the second intermediate frequency signal;
filtering the processed second intermediate frequency signal using the bin mask indicating which one or more bins do not include data corresponding to the distance to the object; and
providing the object data including the information on the distance to the object and the moving speed of the object based on the filtered second intermediate frequency signal.

20. A radar system comprising:
an antenna array mounted to a vehicle; and
one or more processors configured to:
generate a pre-chirp signal including a plurality of pre-chirps and a main chirp signal including a plurality of main chirps to be transmitted through the antenna array to detect an object around the vehicle, and
sequentially transmit radio waves corresponding to the pre-chirp signal and radio waves corresponding to the main chirp signal and receive radio waves reflected from the object through the antenna array,
wherein the number of the pre-chirps included in the pre-chirp signal is smaller than the number of the main chirps included in the main chirp signal.
